(19) United States
(12) Patent Application Publication
(10) Pub. No.: US 2022/0087333 A1
(43) Pub. Date: Mar. 24, 2022

(54) FACE MASKS CONFIGURED TO COUPLE TO EYEWEAR

(71) Applicant: Miles Craigwell, Seattle, WA (US)

(72) Inventor: Miles Craigwell, Seattle, WA (US)

(21) Appl. No.: 17/027,197

(22) Filed: Sep. 21, 2020

(51) Int. Cl. A41D 13/11

(52) U.S. Cl. CPC A41D 13/1161

(57) ABSTRACT

Face masks configured to fit over a nose and a mouth of a user wearing an eyewear article. The face masks include a cover and an eyewear coupler. The cover is configured to the cover the nose and the mouth of the user. The eyewear coupler is attached to the cover and configured to selectively attach to the eyewear article to couple the cover to the eyewear article. In some examples, the face mask includes the eyewear article to define a face-and-eye-mask.

### BACKGROUND

The present disclosure relates generally to face masks. In particular, face masks configured to couple to eyewear are described.

Face masks function as a barrier between the external environment and a person's nose and mouth. The barrier serves to limit or prevent harmful particles, such as viruses, bacteria, or toxic chemicals, from being inhaled by the person wearing the face mask or otherwise entering the person's nose and mouth. Face masks have become more important and more widely used as the world contends with the Covid-19 pandemic.

Known face masks are not entirely satisfactory for the range of applications in which they are employed. For example, existing face masks are cumbersome. Most conventional face masks include straps that must be negotiated and managed. Some face masks require a user to inconveniently tie straps behind his or her head or neck.

Another drawback of conventional face masks is that they are often uncomfortable to wear. Some face masks fit extremely close to a user's face and are prone to interfere with the user's breathing or attempts to talk. Often, face mask straps compress a user's head and neck uncomfortably and irritate a person's skin.

Existing face masks limit a person's ability to interact socially by obscuring the person's lips and expressions. People interacting with someone wearing a conventional face mask formed from opaque materials often struggle to understand what the person is saying because they can not see the person's lips moving like normal. Nonverbal communication is also limited by known, opaque face masks because people are not able to see expressions like smiles, frowns, and scowls.

Conventional face shields suffer from being unwieldy and not closely conformed to a user's face. People wearing face shields often bump into things and have to limit their range of motion to accommodate the face shield.

It would be desirable to have a face mask that was easy to put on and take off. It would be further desirable to have a face mask that was comfortable to wear. Another desirable feature for a face mask would be a shape that closely matches the contours of a person's face. A further improvement over conventional face masks would be utilizing a transparent material that allowed for improved verbal and nonverbal communication.

Thus, there exists a need for face masks that improve upon and advance the design of known face masks. Examples of new and useful face masks relevant to the needs existing in the field are discussed below.

### SUMMARY

The present disclosure is directed to face masks configured to fit over a nose and a mouth of a user wearing an eyewear article. The face masks include a cover and an eyewear coupler. The cover is configured to the cover the nose and the mouth of the user. The eyewear coupler is attached to the cover and configured to selectively attach to the eyewear article to couple the cover to the eyewear article. In some examples, the face mask includes the eyewear article to define a face-and-eye-mask.

### BRIEF DESCRIPTION OF THE DRAWINGS

FIG. 1 is a perspective view of a face mask covering a user's nose and mouth and coupled to an eyewear article.

FIG. 2 is front elevation view of the face mask shown in FIG. 1.

FIG. 3 is a rear elevation view of the face mask shown in FIG. 1

FIG. 4 is a side view of the face mask shown in FIG. 1.

FIG. 5 is a front elevation view of the face mask shown in FIG. 1 coupled to a pair of eyeglasses to define a face-and-eyes mask.

### DETAILED DESCRIPTION

The disclosed face masks will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various face masks are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Face Masks Configured to Couple to Eyewear

With reference to the figures, face masks configured to couple to eyewear will now be described. The face masks discussed herein provide a barrier between the external environment and a person's nose and mouth. The barrier serves to limit or prevent harmful particles, such as viruses, bacteria, or toxic chemicals, from being inhaled by the person wearing the face mask or otherwise entering the person's nose and mouth.

The reader will appreciate from the figures and description below that the presently disclosed face masks address many of the shortcomings of conventional face masks. For example, the face masks described herein are convenient to use and do not require straps. Not requiring straps avoids the hassles associated with managing, negotiating, and tying them.

The face masks disclosed in this document are comfortable to wear. The presently described face masks are spaced adequately from the user's face and to avoid interfering with the user's breathing and talking mechanics. With the masks described below, the user's head and neck are not uncomfortably compressed or irritated by straps.

The presently described face masks use transparent materials to not limit a person's ability to interact socially by obscuring the person's expressions. People interacting with the person wearing the face masks described herein are better able to understand what the person is saying because they can see the person's lips moving. Nonverbal communication is also enabled by the face masks discussed herein because people can see expressions like smiles, frowns, and scowls when the person is wearing the face mask.

Unlike unwieldy, conventional face shields, the presently described face masks closely conform to a user's face. The close conforming nature of the face masks described herein enable people wearing them to have a wider range of unimpeded motion. The presently described face masks also reduce the chance of bumping into things because of the face mask extending beyond the person's face contours.

The reader will see below that the face masks disclosed herein are easy to put on and take off; are comfortable to wear, have a shape that closely matches the contours of a person's face; and allow for improved verbal and nonverbal communication.

Contextual Details

Ancillary features relevant to the face masks described herein will first be described to provide context and to aid the discussion of the face masks.

Eyewear Article

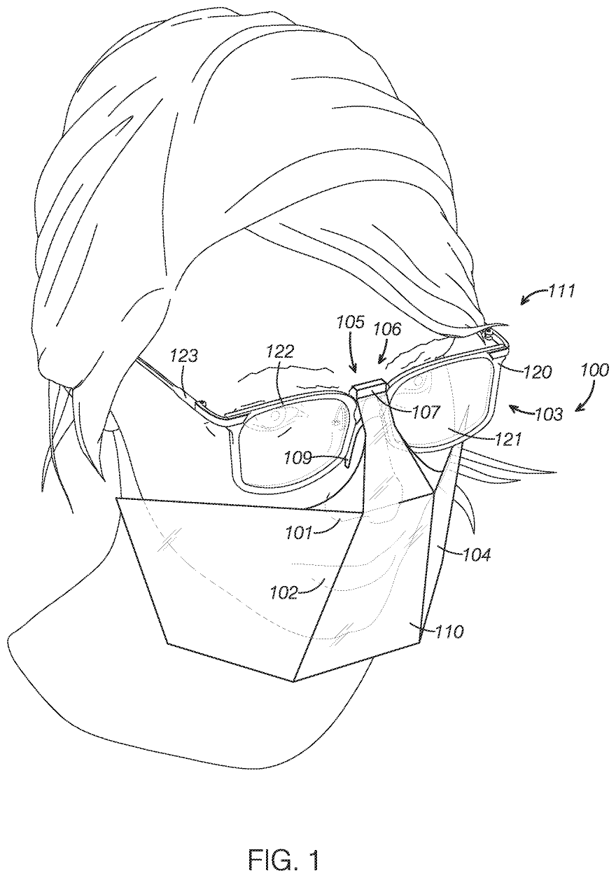

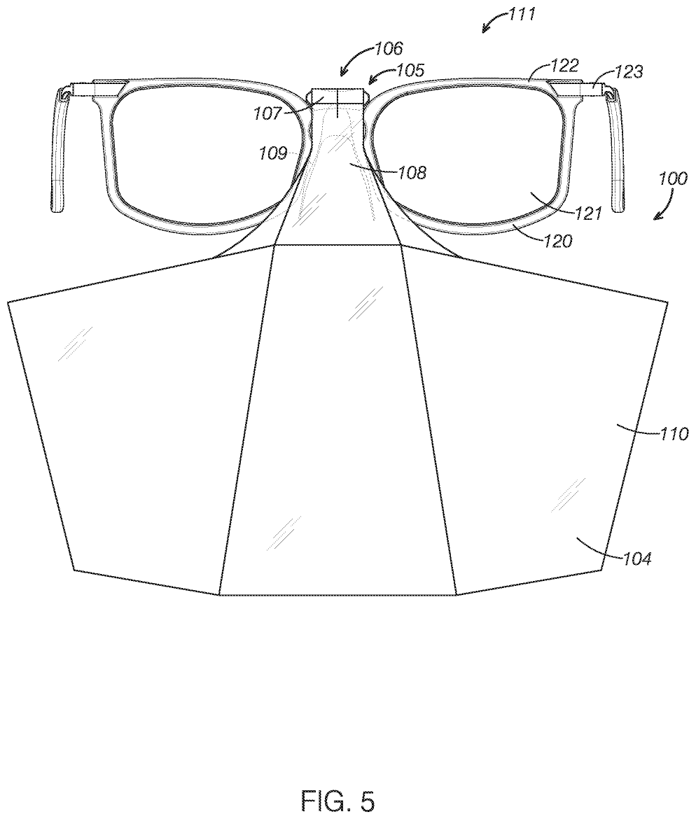

FIGS. 1 and 5 depict an eyewear article 103 to which a face mask 100 selectively couples. The combination of eyewear article 103 and face mask 100 defines a face-and-eye mask 111.

Eyewear article 103 functions to focus light directed to the user's eyes to improve the user's vision. Eyewear article 103 also serves to protect a user's eyes from flying debris and impacts from other objects. Another function of eyewear article 103 is to limit the user's eyes to exposure to viruses and other harmful particles. In some examples, the eyewear article limits the transmission of sunlight reaching the user's eyes.

With reference to FIGS. 1 and 5, the reader can see that eyewear article 103 comprises eyeglasses. In other examples, the eyewear article comprises sunglasses, goggles, or safety glasses.

In the example shown in FIGS. 1 and 5, eyewear article 103 includes a frame 120 and lenses 121. Frame 120 includes a bridge 106, lens supports 122, and arms 123. In the present example, lenses 121 are prescription lenses. In other examples, the lenses and non-prescription lenses and function simply to protect or shade the wearer's eyes.

The eyewear article may be any currently known or later developed type of eyewear article. The reader will appreciate that a variety of eyewear article types exist and could be used in place of the eyewear article shown in the figures. In addition to the types of eyewear articles existing currently, it is contemplated that the face masks described herein could be used with new types of eyewear articles developed in the future.

The shape of the eyewear article may be adapted to be different than the specific examples shown in the figures to suit a given application. In some examples, the shape of the eyewear article may be dictated by aesthetics or fashion. Additionally or alternatively, the shape of the eyewear article may be dictated by safety, barrier effectiveness, and/or injury prevention.

The size of the eyewear article may be varied as needed for a given application. In some examples, the eyewear article is larger relative to the other components than depicted in the figures. In other examples, the eyewear article is smaller relative to the other components than depicted in the figures. Further, the reader should understand that the eyewear article and the other components may all be larger or smaller than described herein while maintaining their relative proportions.

Face Mask

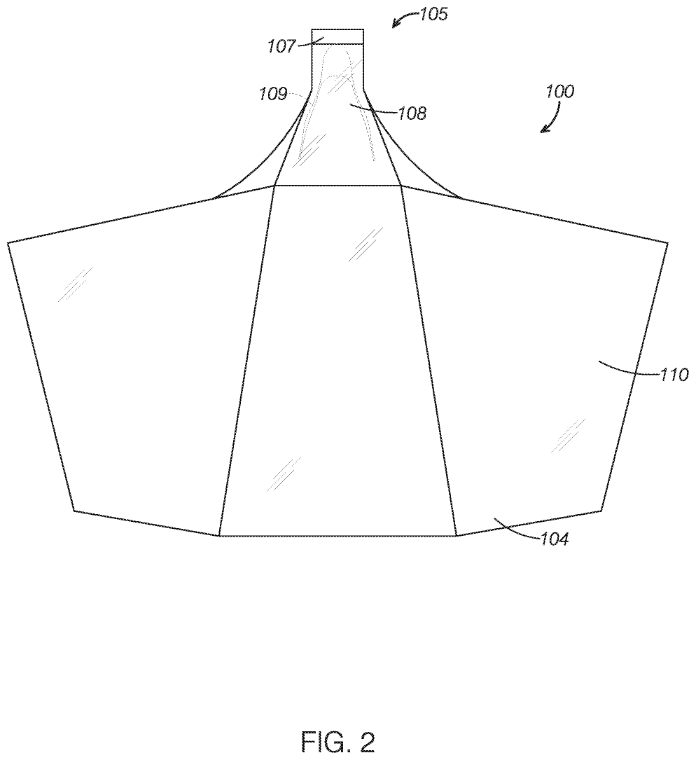

With reference to FIGS. 1-5, a face mask 100 will now be described as a first example of a face mask. As shown in FIG. 1, face mask 100 is configured to fit over a nose 101 and a mouth 102 of a user wearing an eyewear article 103.

The reader can see in FIGS. 1-5 that face mask 100 includes a cover 104 and an eyewear coupler 105. In other examples, the face mask includes fewer components than depicted in the figures. In certain examples, the face mask includes additional or alternative components than depicted in the figures. As depicted in FIGS. 1 and 5, eyewear article 103 is coupled to eyewear coupler 105 to define a face-and-eye mask.

The size of the face mask may be varied as needed for a given application. In some examples, the face mask is larger relative to the other components than depicted in the figures. In other examples, the face mask is smaller relative to the other components than depicted in the figures. Further, the reader should understand that the face mask and the other components may all be larger or smaller than described herein while maintaining their relative proportions.

The shape of the face mask may be adapted to be different than the specific examples shown in the figures to suit a given application. The face mask may be composed of any currently known or later developed material or materials suitable for the applications described herein for which it is used. Suitable materials include metals, polymers, fabrics, wood, and composite materials.

Cover

As shown in FIG. 1, cover 104 is configured to cover nose 101 and mouth 102 of the user. With reference to FIG. 1, the reader can see that cover 104 closely conforms to the shape and contours of the user's face, including the user's cheeks, mouth 102, and nose 101. Cover 104 provides extensive coverage of the user's face without extending substantially beyond the boundaries of the users face, which makes face mask 100 more comfortable and maneuverable.

The reader can see in FIGS. 1-5 that cover 104 is a rigid material 110. In the example shown in FIGS. 1-5, cover 104 is transparent. However, other examples may utilize opaque or semi-transparent materials. In examples where the cover is transparent, the user's ability to communicate verbally and nonverbally is enhanced.

Cover 104 being rigid allows cover 104 to maintain a spaced relationship with the users face when face mask 100 is worn. The spaced relationship increases the user's comfort. The spaced relationship and cover 104 being rigid also avoids a portion of cover 104 being sucked into a user's mouth as he or she inhales, which can happen with cloth face masks.

In the present example, cover 104 is composed of a polymer. However, the cover may be composed of any currently known or later developed material suitable for the applications described herein for which it is used. Suitable materials include metals, polymers, fabrics, wood, and composite materials.

The size of the cover may be varied as needed for a given application. In some examples, the cover is larger relative to the other components than depicted in the figures. In other examples, the cover is smaller relative to the other components than depicted in the figures. Further, the reader should understand that the cover and the other components may all be larger or smaller than described herein while maintaining their relative proportions.

The shape of the cover may be adapted to be different than the specific examples shown in the figures to suit a given application. For example, the cover may include a face having the shape of a regular or irregular polygon, such as a circle, oval, triangle, square, rectangle pentagon, and the like. Additionally or alternatively, the cover may include a face having an irregular shape.

The cover may be any currently known or later developed type of cover. The reader will appreciate that a variety of cover types exist and could be used in place of the cover shown in the figures. In addition to the types of covers existing currently, it is contemplated that the face masks described herein could incorporate new types of covers developed in the future.

Rigid Material

Rigid material 110 functions to cover the user's face and to block viruses or other harmful particles from reaching the users nose and mouth. As depicted in FIGS. 1-5, rigid material 110 is a polymer. With reference to FIG. 1, rigid material 110 is transparent.

In the present example, rigid material 110 is composed of a polymer. However, the rigid material may be composed of any currently known or later developed material suitable for the applications described herein for which it is used. Suitable materials include metals, polymers, wood, and composite materials.

Eyewear Coupler

The role of eyewear coupler 105 is to couple cover 104 to eyewear article 103. As shown in FIGS. 1-5, eyewear coupler 105 is attached to cover 104 and configured to selectively attach to eyewear article 103 to couple cover 104 to eyewear article 103. The reader can see in FIGS. 1 and 5 that eyewear coupler 105 is configured to selectively attach to bridge 106 of eyewear article 103.

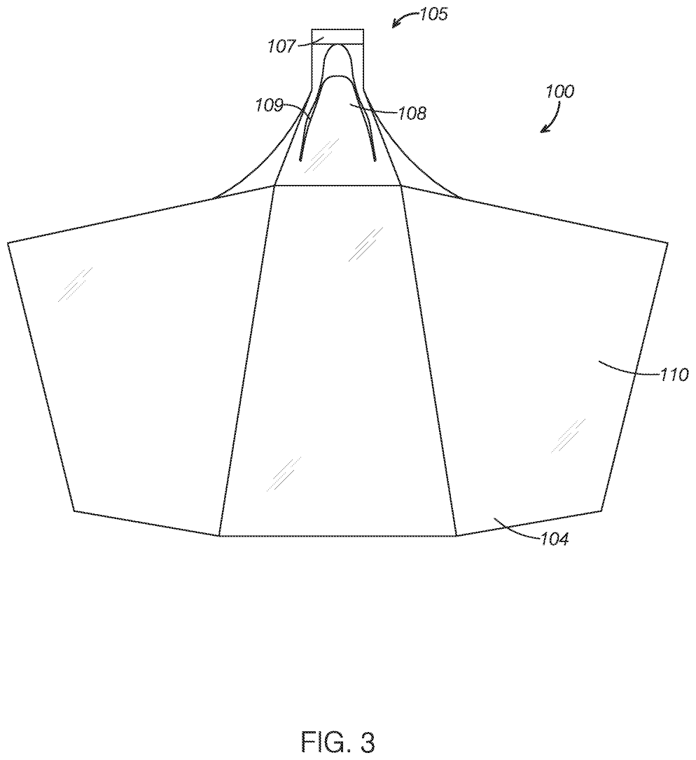

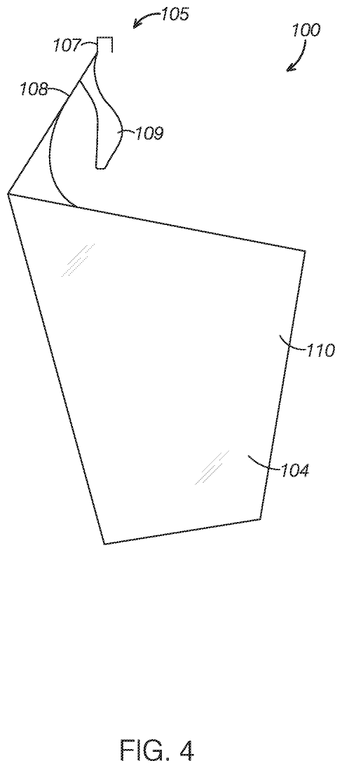

With reference to FIGS. 3 and 4, eyewear coupler 105 includes a clip 107, a body 108 and nose pads 109. As depicted in FIGS. 1 and 5, clip 107 is configured to selectively attach to bridge 106 of eyewear article 103.

In the present example, eyewear coupler 105 is composed of a polymer. However, the eyewear coupler may be composed of any currently known or later developed material suitable for the applications described herein for which it is used. Suitable materials include metals, polymers, wood, and composite materials.

The size of the eyewear coupler may be varied as needed for a given application. In some examples, the eyewear coupler is larger relative to the other components than depicted in the figures. In other examples, the eyewear coupler is smaller relative to the other components than depicted in the figures. Further, the reader should understand that the eyewear coupler and the other components may all be larger or smaller than described herein while maintaining their relative proportions.

The shape of the eyewear coupler may be adapted to be different than the specific examples shown in the figures to suit a given application.

The eyewear coupler may be any currently known or later developed type of coupler. The reader will appreciate that a variety of coupler types exist and could be used in place of the eyewear coupler shown in the figures. In addition to the types of couplers existing currently, it is contemplated that the face masks described herein could incorporate new types of couplers developed in the future.

Clip

As shown in FIGS. 1 and 3-5, clip 107 is configured to selectively attach to bridge 106 of eyewear article 103. In the present example, clip 107 is resilient and selectively attaches to bridge 106 via a friction fit. However, other means of selective attachment may be used, such as hook-and-loop fasteners, magnetic coupling, and mechanical fasteners.

The clip may be any currently known or later developed type of clip. The reader will appreciate that a variety of clip types exist and could be used in place of the clip shown in the figures. In addition to the types of clips existing currently, it is contemplated that the face masks described herein could incorporate new types of clips developed in the future.

The shape of the clip may be adapted to be different than the specific examples shown in the figures to suit a given application. For example, the clip may include a face having the shape of a regular or irregular polygon, such as a circle, oval, triangle, square, rectangle pentagon, and the like. Additionally or alternatively, the clip may include a face having an irregular shape. In three dimensions, the shape of the clip may be a sphere, a pyramid, a cone, a cube, and variations thereof, such as a hemisphere or a frustoconical shape.

The size of the clip may be varied as needed for a given application. In some examples, the clip is larger relative to the other components than depicted in the figures. In other examples, the clip is smaller relative to the other components than depicted in the figures. Further, the reader should understand that the clip and the other components may all be larger or smaller than described herein while maintaining their relative proportions.

Body

Body 108 serves to provide structure for eyewear coupler 105 and to support other components of eyewear coupler 105, including clip 107 and nose pads 109. The reader can see in FIGS. 1 and 5 that body 108 is attached to clip 107 and to cover 104.

In the present example, body 108 is composed of a polymer. However, the body may be composed of any currently known or later developed material suitable for the applications described herein for which it is used. Suitable materials include metals, polymers, wood, and composite materials.

The size of the body may be varied as needed for a given application. In some examples, the body is larger relative to the other components than depicted in the figures. In other examples, the body is smaller relative to the other components than depicted in the figures. Further, the reader should understand that the body and the other components may all be larger or smaller than described herein while maintaining their relative proportions.

The shape of the body may be adapted to be different than the specific examples shown in the figures to suit a given application. For example, the body may include a face having the shape of a regular or irregular polygon, such as a circle, oval, triangle, square, rectangle pentagon, and the like. Additionally or alternatively, the body may include a face having an irregular shape.

Nose Pads

The role of nose pads 109 is to interface with user's nose to support face mask 100 more securely. Nose pads 109 also function to distribute the weight of face mask 100 over a wider area to make wearing face mask 100 more comfortable for the user.

As depicted in FIGS. 1, 3, and 4, nose pads 109 are attached to body 108. With reference to FIGS. 1, 3, and 4, the reader can see that nose pads 109 are attached to body 108 in a position spaced from clip 107. Nose pads 109 are positioned to not interfere with eyewear article 103

Nose pads 109 define two planar support members. The reader can see in FIG. 4 that planar support members define curved contours when viewed in profile. The shape of the planar support members may be varied as needed for ergonomics and user comfort. In some examples, the nose pads include cushions suspended from arms rather than curved planar members.

In the present example, nose pads 109 are comprised of a polymer. However, the nose pads may be composed of any currently known or later developed material suitable for the applications described herein for which it is used. Suitable materials include metals, polymers, wood, and composite materials.

The size of the nose pad may be varied as needed for a given application. In some examples, the nose pad is larger relative to the other components than depicted in the figures. In other examples, the nose pad is smaller relative to the other components than depicted in the figures. Further, the reader should understand that the nose pad and the other components may all be larger or smaller than described herein while maintaining their relative proportions.

The shape of the nose pads may be adapted to be different than the specific examples shown in the figures to suit a given application. For example, the nose pads may include a face having the shape of a regular or irregular polygon, such as a circle, oval, triangle, square, rectangle pentagon, and the like. Additionally or alternatively, the nose pads may include a face having an irregular shape. In three dimensions, the shape of the nose pads may be a sphere, a pyramid, a cone, a cube, and variations thereof, such as a hemisphere or a frustoconical shape.

The number of nose pads in the face mask may be selected to meet the needs of a given application. The reader should understand that the number of nose pads may be different in other examples than is shown in the figures. For instance, some face mask examples include additional or fewer nose pads than described in the present example.

The nose pads may be any currently known or later developed type of nose pad. The reader will appreciate that a variety of nose pad types exist and could be used in place of the nose pads shown in the figures. In addition to the types of nose pads existing currently, it is contemplated that the face masks described herein could incorporate new types of nose pads developed in the future.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A face mask configured to fit over a nose and a mouth of a user wearing an eyewear article, the face mask comprising:
a cover configured to cover the nose and the mouth of the user; and
an eyewear coupler attached to the cover and configured to selectively attach to the eyewear article to couple the cover to the eyewear article.

2. The face mask of claim 1, wherein the eyewear coupler is configured to selectively attach to a bridge of the eyewear article.

3. The face mask of claim 2, wherein the eyewear coupler includes a clip configured to selectively attach to the bridge of the eyewear article.

4. The face mask of claim 3, wherein the clip is resilient and configured to selectively attach to the bridge of the eyewear article via a friction fit.

5. The face mask of claim 3, wherein the eyewear coupler includes:
a body attached to the clip; and
a nose pad attached to the body.

6. The face mask of claim 5, wherein the nose pad is spaced from the clip.

7. The face mask of claim 1, wherein the cover is a rigid material.

8. The face mask of claim 7, wherein the rigid material is a polymer.

9. The face mask of claim 7, wherein the rigid material is transparent.

10. The face mask of claim 1, further comprising the eyewear article coupled to the eyewear coupler to define a face-and-eye mask.

11. The face mask of claim 10, wherein the eyewear article comprises eyeglasses.
